(19) United States
(12) Patent Application Publication
(10) Pub. No.: US 2010/0102047 A1
(43) Pub. Date: Apr. 29, 2010

(54) WELDING ROD EXPANDER ASSEMBLY

(76) Inventors: Patrick Malloy, Cookstown, NJ (US); Norma J. Malloy, Cookstown, NJ (US)

Correspondence Address: L.C. BEGIN & ASSOCIATES, PLLC, 510 HIGHLAND AVENUE, PMB 403, MILFORD, MI, 48381, US

(21) Appl. No.: 12/603,193

(22) Filed: Oct. 21, 2009

Related U.S. Application Data
(60) Provisional application No. 61/107,710, filed on Oct. 23, 2008.

(51) Int. Cl. B23K 9/28

(52) U.S. Cl. 219/136; 219/138

(57) ABSTRACT

One embodiment of a welding rod expander assembly for expanding a welding rod to a remote location. The welding rod expander assembly may include a first attachment member, a second attachment member, at least one elongated member and a welding rod holder. The second attachment member may be pivotally carried by the first attachment member. Further the at least one elongated member may have an external threaded end portion and a connecting end portion. The welding rod holder may be carried by the second attachment member. The welding rod holder may include a holding unit carried by the second internal threaded portion. The holding unit may be capable of receiving the welding rod. The welding rod holder may further include a clamping unit disposed on the second internal threaded portion. Further, the welding rod secured in the holding unit may be capable of expanding to the remote location.

### CROSS REFERENCE TO RELATED APPLICATION

This application claims the benefit of U.S. Provisional Application No. 61/107,710 filed on Oct. 23, 2008, the disclosure of which is incorporated by reference.

### FIELD OF THE DISCLOSURE

The present disclosure generally relates to arc welding tools, and more particularly, to a welding rod expander assembly adapted to expand a welding rod to a remote location.

### BACKGROUND OF THE DISCLOSURE

Arc welding, more specifically, shielded metal arc welding (SMAW), employs an electric arc to melt a work material and a welding rod to lay a weld. An electric current forms the electric arc between the welding rod and the work material to be welded.

The welding procedure is dependant on the electrode rod, composition of the work material and location of a joint to be welded Minimal skill is required for welding a flat joint. Further, welding the flat joint may be done with a welding rod that may melt quickly but solidify slowly. However, welding sloped, vertical or upside-down joint takes steady hands and an eye for detail. Further, welding joints at a remote location i.e., an inaccessible location is a cumbersome process and also associated with risk to life and limb. In order to weld a joint at the remote location, a welder may have to periodically stop the welding procedure in order to stretch to the remote location. Further, the welder may have to first weld more than one welding rod together to increase the length of the welding rod in order to make the welding rod reach the remote location. Such an extended welding rod may be subjected to breakage which may present a greater danger to the welder.

### SUMMARY OF THE DISCLOSURE

One embodiment of a welding rod expander assembly for expanding a welding rod to a remote location. The welding rod expander assembly may be adapted to be carried by a stinger. The welding rod expander assembly may include a first attachment member, a second attachment member, at least one elongated member and a welding rod holder. The first attachment member may have a first internal threaded portion and a first attachment portion. The second attachment member may have a second internal threaded portion and a second attachment portion. The second attachment portion may be pivotally carried by the first attachment portion. Further the at least one elongated member may have an external threaded end portion and a connecting end portion. The external threaded end portion may be capable of being removably carried by the first internal threaded portion and the connecting end portion may be capable of being removably carried by the stinger. Furthermore, the welding rod holder may be carried by the second attachment member. The welding rod holder may include a holding unit carried by the second internal threaded portion. The holding unit may be capable of receiving the welding rod. The welding rod holder may further include a clamping unit disposed on the second internal threaded portion. The clamping unit may be capable of assuming at least one of an open position and a closed position. In the open position, the clamping unit may be capable of securing the welding rod in the holding unit. Further, the welding rod secured in the holding unit may be capable of expanding to the remote location.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of an embodiment of a welding rod expander assembly;

FIG. 2 is a perspective view of a first attachment member of the welding rod expander assembly of FIG. 1;

FIG. 3 is a perspective view of a second attachment member of the welding rod expander assembly of FIG. 1;

FIG. 4 is a perspective view the second attachment member carried by the first attachment member of the welding rod expander assembly of FIG. 1; and

FIG. 5 is a perspective view of an elongated member of the welding rod expander assembly of FIG. 1; and

FIG. 6 is an exploded view of a welding rod holder of the welding rod expander assembly of FIG. 1.

Like reference numerals refer to like parts throughout the description of several views of the drawings.

### DETAILED DESCRIPTION OF THE DISCLOSURE

The exemplary embodiments described herein provide detail for illustrative purposes and are subject to many variations in structure and design. It should be emphasized, however, that the present disclosure is not limited to a particular welding rod expander assembly, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present disclosure provides a welding rod expander assembly for expanding a welding rod to a remote location. The term “welding rod” as used herein relates to a consumable electrode coated in flux utilized during a welding procedure.

The term “stinger” as used herein relates to a conventional welding tool utilized for holding the welding rod.

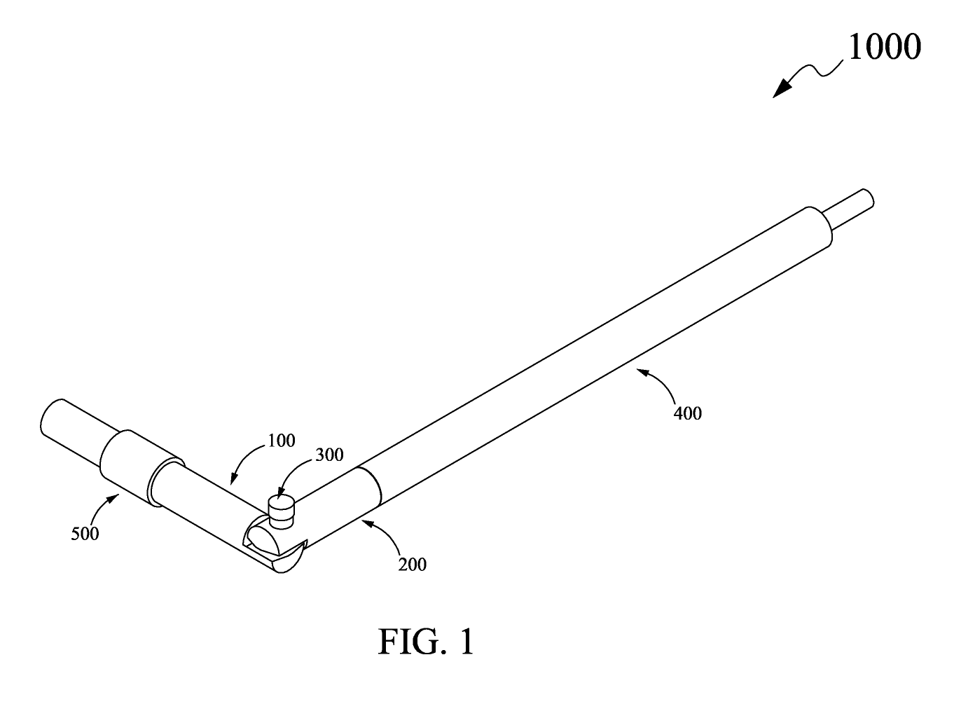

Referring to FIG. 1, one embodiment of a welding rod expander assembly 1000 is shown, that may be adapted to be mounted to a conventional stinger (not shown) employed in a welding operation.

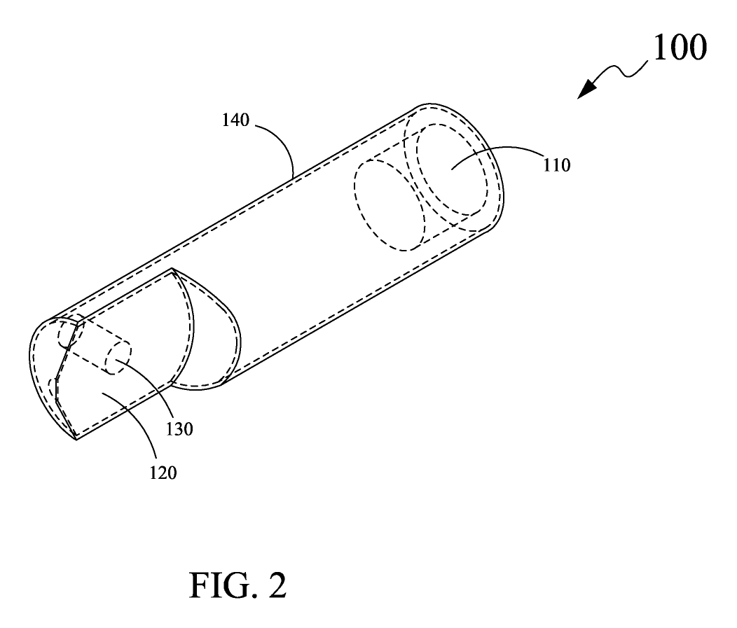

Referring to FIGS. 1 and 2, the welding rod expander assembly 1000 may include a first attachment member 100 having a first internal threaded portion 110 and a first attachment portion 120. The first attachment portion 120 may include a first threaded opening 130. Further, the first attachment member 100 may be covered by a first insulated covering 140 configured to withstand extreme heat generated during welding operation. The first attachment member 100 may be made of any heat resistant and durable material such as copper, and the like.

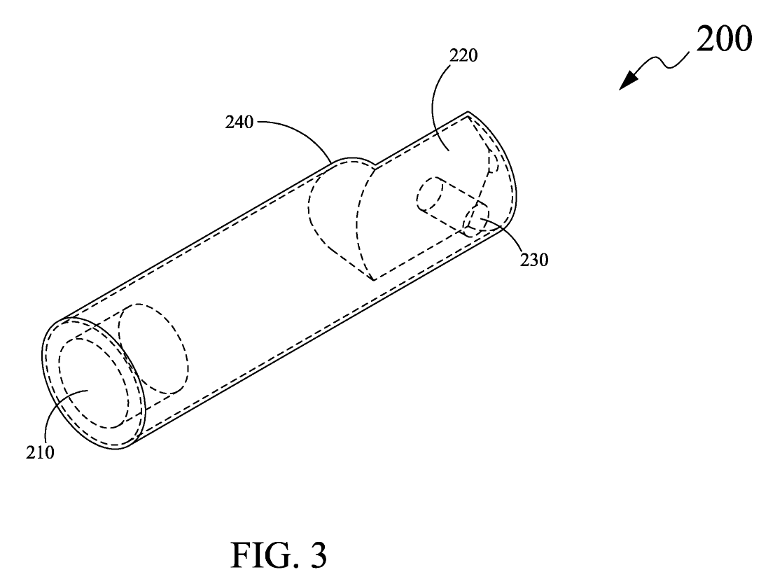

Referring to FIGS. 1 and 3, the welding rod expander assembly 1000 may include a second attachment member 200 having a second internal threaded portion 210 and a second attachment portion 220. The second attachment portion 220 may include a second threaded opening 230. Further, the second attachment member 200 may be covered by a second insulated covering 240 configured to withstand extreme heat generated during welding operation. The second attachment member 200 may be made of any heat resistant and durable material such as copper, and the like.

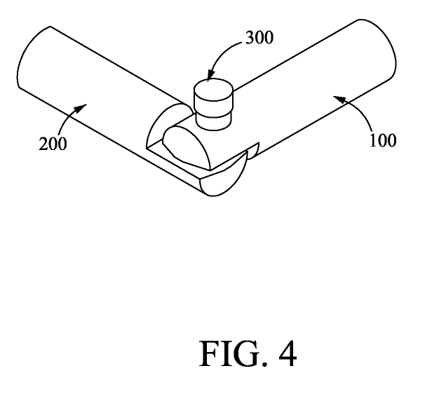

Further, as shown in FIGS. 1 and 4, the second attachment member 200 may pivotally carry the first attachment member 100. More specifically, the first threaded opening 130 may be aligned with the second threaded opening 230 and the first threaded opening 130 and the second threaded opening 230 may be secured by a fastening member 300, in order to allow the first attachment member 100 and the second attachment member 200 to swivel from about 0 degree to 175 degree. In an embodiment of the present disclosure, the fastening member 300 is a thumbscrew. However, it will be pertinent to mention here that the thumbscrew has been mentioned for purpose of illustration only and may not be construed as limiting the scope of present disclosure.

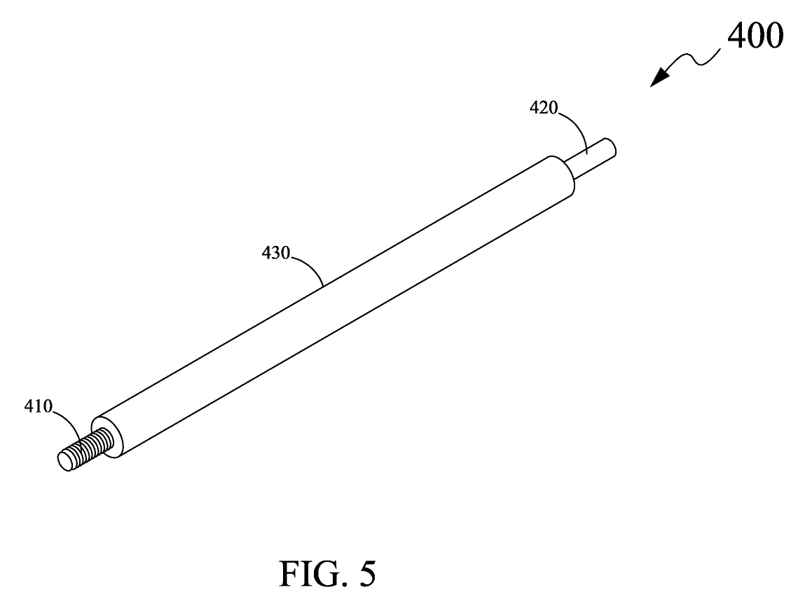

Referring to FIGS. 1 and 5, the welding rod expander assembly 1000 may further have one or more elongated members 400 that may include an external threaded end portion 410 and a connecting end portion 420. The external threaded end portion 410 may be carried by the first internal threaded portion 110 and the connecting end portion 420 may be carried by the stinger. The elongated member 400 may be made of any sturdy and heat resistant material such as alloy 182, chromium, copper and the like. Further, the elongated member 400 may be covered by a third insulated covering 430 configured to withstand extreme heat generated during welding operation. Furthermore, more than one elongated member that may be joined together in serial order to increase the overall length of the welding rod expander assembly 1000.

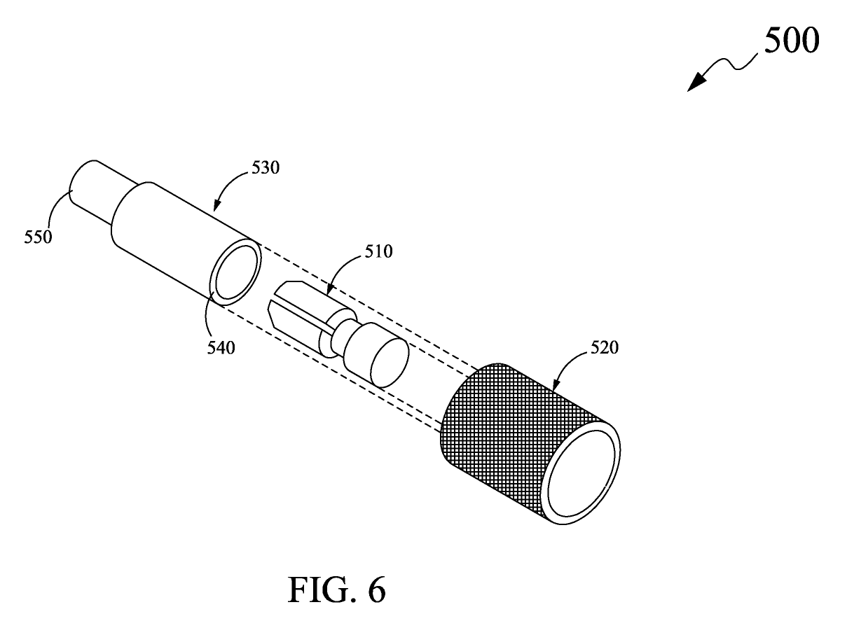

Further, referring to FIGS. 1 and 6, the welding rod expander assembly 1000 may include a welding rod holder 500 having a holding unit 510 and a clamping unit 520. The welding rod holder 500 may be carried by the second attachment member 200. More specifically, the holding unit 510 may be carried by the second internal threaded portion 210 and the clamping unit 520 may be disposed on the second internal threaded portion 210. An example of the holding unit 510 may be a collet. Further, the clamping unit 520 may be capable of assuming at least one of an open position and a closed position. More specifically, in the open position, the clamping unit 520 may secure the welding rod carried by the holding unit 510 in a manner such that the welding rod may be incapable of disengaging from the welding rod holder 500. In the closed position, the welding rod may be capable of being released from the holding unit 510. The holding unit 510 and the clamping unit 520 may be made of a material which may be capable of withstanding the extreme heat generated during the welding procedure. In an embodiment of the present disclosure, the holding unit 510 may be made of alloy 510, phosphor bronze, and the like and the clamping unit 520 may be made of G10/FR4 garlite material, and the like. However, it may be evident that the material of construction of the holding unit 510 and the clamping unit 520 has been shown here for purpose of illustration and may not be construed as limiting the scope of the present disclosure. Further, the welding rod expander assembly 1000 may include a shielding member 530 carried by the welding rod holder 500. The shielding member 530 may include a first open end 540 and a second open end 550. The first open end 540 may be disposed in the clamping unit 520 in a manner such that the holding unit 510 may be surrounded by the shielding member 530. Further, the second open end 550 may be capable of allowing the welding rod to pass there through such that the welding rod is received in the holding unit 510. The shielding member 530 may be made of a material which is capable of withstanding extreme heat. An example of the material used for the construction of the shielding member 530 may be porcelain. However, it may be evident that the material of construction of the shielding member 530 has been shown here for purpose of illustration and may not be construed as limiting the scope of the present disclosure.

In use, the welding rod expander assembly 1000 may be capable of being carried by a stinger employed during welding procedure. More specifically, the connecting end portion 420 of the elongated member 400 may be capable of being carried by the stinger. Further, the welding rod may be capable of being carried by the welding rod expander assembly 1000 in a manner such that the welding rod may be received by the welding rod holder 500. Further, the clamping unit 520 may assume at least one of an open position and a closed position. More specifically, in the open position, the clamping unit 520 may secure the welding rod carried by the holding unit 510 in a manner such that the welding rod may be incapable of disengaging from the welding rod holder 500. Further, the open position of the clamping unit 520 may be capable of expanding the welding rod to a remote location. More specifically, the welding rod expander assembly 1000 may be employed for making the welding rod to reach to the remote location which is inaccessible. After the welding operation has been conducted or to release the welding rod from the welding rod holder 500, the clamping unit 520 is worked upon to release the welding rod from the holding unit 510 such that the clamping unit 520 may assume the closed position.

The welding rod expander assembly 1000 may be beneficial for making the welding rod reach remote locations during welding operation. Specifically, the welding rod expander assembly precludes the need of combining more than one welding rod for reaching remote locations. Further, the welding rod expander assembly provides a mean for reaching remote locations without compromising safety of a welder. Further, various components of the welding rod expander assembly may withstand extreme heat generated during the welding procedure and as such assist the welder to conduct the welding procedure for extended period of time. Furthermore, the welding rod expander assembly may be simple in construction and easy to use.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present disclosure.

What is claimed is:

1. A welding rod expander assembly for expanding a welding rod to a remote location, the welding rod expander assembly adapted to be carried by a stinger, the welding rod expander assembly comprising:
a first attachment member having a first internal threaded portion and a first attachment portion;
a second attachment member having a second internal threaded portion and a second attachment portion, the second attachment portion pivotally carried by the first attachment portion;
at least one elongated member having an external threaded end portion and a connecting end portion, the external threaded end portion capable of being removably carried by the first internal threaded portion and the connecting end portion capable of being removably carried by the stinger; and
a welding rod holder carried by the second attachment member, the welding rod holder comprising
a holding unit carried by the second internal threaded portion, the holding unit capable of receiving the welding rod, and
a clamping unit disposed on the second internal threaded portion, the clamping unit capable of assuming at least one of an open position and a closed position,
wherein the open position of the clamping unit is capable of securing the welding rod in the holding unit, and
wherein the welding rod secured in the holding unit is capable of expanding to the remote location.

2. The welding rod expander assembly of claim 1 further comprising shielding member having a first open end and a second open end, the first open end capable of being threadably carried by the welding rod holder and the second open end capable of allowing the welding rod to pass there through.

3. The welding rod expander assembly of claim 1, wherein the second attachment portion is pivotally carried by the first attachment portion with a means of a fastening member.

4. The welding rod expander assembly of claim 3, wherein the fastening member is a thumbscrew.

5. The welding rod expander assembly of claim 1, wherein the first attachment member is covered with a first insulated covering for withstanding extreme heat.

6. The welding rod expander assembly of claim 1, wherein the second attachment member is covered with a second insulated covering for withstanding extreme heat.

7. The welding rod expander assembly of claim 1, wherein the at least one elongated member is covered with a third insulated covering for withstanding extreme heat.
